(19) United States
(12) Patent Application Publication
(10) Pub. No.: US 2024/0078387 A1
(43) Pub. Date: Mar. 7, 2024

(54) TEXT CHAIN GENERATION METHOD AND APPARATUS, DEVICE, AND MEDIUM

(71) Applicant: BEIJING YOUZHUJU NETWORK TECHNOLOGY CO., LTD., Beijing (CN)

(72) Inventors: Jiangtao FENG, Beijing (CN); Jiaze CHEN, Beijing (CN); Hao ZHOU, Beijing (CN); Lei LI, Beijing (CN)

(21) Appl. No.: 18/262,508

(22) PCT Filed: Jan. 24, 2022
(86) PCT No.: PCT/CN2022/073402

§ 371 Date: Jul. 21, 2023

(30) Foreign Application Priority Data
Jan. 22, 2021 (CN) 202110090507.0

(51) Int. Cl. G06F 40/289

(52) U.S. Cl. CPC G06F 40/289

(57) ABSTRACT

A text chain generation method includes selecting a to-be-matched phrase chain from a phrase chain set to match the initial phrase chain and determining the largest common subsequence between the to-be-matched phrase chain and the initial phrase chain; updating the initial phrase chain by adding a word from the to-be-matched phrase chain and other than the largest common subsequence into the initial phrase chain; using the updated initial phrase chain as a new initial phrase chain and repeating the previous steps until traversing all phrase chains in the phrase chain set to obtain an updated phrase chain; and connecting a left node located in each branch of the updated phrase chain and not connected to any node to a preset common start node and connecting a right node located in each branch of the updated phrase chain and not connected to any node to a preset common end node.

This application claims priority to Chinese Patent Application No. 202110090507.0 filed with the China National Intellectual Property Administration (CNIPA) on Jan. 22, 2021, the disclosure of which is incorporated herein by reference in its entirety.

### TECHNICAL FIELD

Embodiments of the present disclosure relate to the field of computer application, for example, a text chain generation method and apparatus, a device, and a medium

### BACKGROUND

In advertising or other fields, to describe a target item, it is required to search for corresponding text content in a text database. To augment a phrase text database, it is usual practice to extract phrases from existing related long text or use a trained neural network model to generate related phrases based on input text. However, in the related solution, the phrase extraction method can extract only a limited number of words from the existing text. Moreover, the neural-network-model-based generation method sometimes generates linguistically illogical words, so the model used requires more training.

### SUMMARY

Embodiments of the present disclosure provide a text chain generation method and apparatus, a device, and a medium, forming a phrase set based on syntactic structure reconstruction, quickly and efficiently generating more phrases, and enriching phrase corpus resources.

In a first aspect, an embodiment of the present disclosure provides a text chain generation method. The method includes selecting a to-be-matched phrase chain from a phrase chain set to match the initial phrase chain and determining the largest common subsequence between the to-be-matched phrase chain and the initial phrase chain, where the phrase chain set includes a plurality of phrase chains, where each of the plurality of phrase chains refers to a text chain formed by nodes connected in a phrase order, where all words in at least one phrase constitute the nodes; updating the initial phrase chain by forming a branch of the initial phrase chain by adding a word from the to-be-matched phrase chain and other than the largest common subsequence into the initial phrase chain, where the largest common subsequence serves as the common node; using the updated initial phrase chain as a new initial phrase chain and repeating the previous steps until traversing all phrase chains in the phrase chain set to obtain an updated phrase chain; and connecting a left node located in each branch of the updated phrase chain and not connected to any node to a preset common start node and connecting a right node located in each branch of the updated phrase chain and not connected to any node to a preset common end node to obtain the final phrase chain.

In a second aspect, an embodiment of the present disclosure provides a text chain generation apparatus. The apparatus includes a common sequence matching module configured to select a to-be-matched phrase chain from a phrase chain set to match the initial phrase chain and determine the largest common subsequence between the to-be-matched phrase chain and the initial phrase chain, where the phrase chain set includes a plurality of phrase chains, where each of the plurality of phrase chains refers to a text chain formed by nodes connected in a phrase order, where all words in at least one phrase constitute the nodes; a phrase chain update module configured to update the initial phrase chain by forming a branch of the initial phrase chain by adding a word from the to-be-matched phrase chain and other than the largest common subsequence into the initial phrase chain, where the largest common subsequence serves as the common node; a matching chain update module configured to use the updated initial phrase chain as a new initial phrase chain and call the common sequence matching module and the phrase chain update module to repeat the previous steps until traversing all phrase chains in the phrase chain set to obtain an updated phrase chain; and a text processing module configured to connect a left node located in each branch of the updated phrase chain and not connected to any node to a preset common start node and connect a right node located in each branch of the updated phrase chain and not connected to any node to a preset common end node to obtain the final phrase chain.

In a third aspect, an embodiment of the present disclosure provides an electronic device. The electronic device includes one or more processors; and a memory configured to store one or more programs.

When the one or more programs are executed by the one or more processors, the one or more processors are caused to perform the text chain generation method of any embodiment of the present disclosure.

In a fourth aspect, an embodiment of the present disclosure provides a computer storage medium storing a computer program which, when executed by a processor, causes the processor to perform the text chain generation method of any embodiment of the present disclosure.

### BRIEF DESCRIPTION OF DRAWINGS

The same or similar reference numerals throughout the drawings denote the same or similar elements. It is to be understood that the drawings are illustrative and that originals and elements are not necessarily drawn to scale.

FIG. 1 is a flowchart of a text chain generation method according to an embodiment of the present disclosure.

FIG. 2 is a diagram illustrating structures of text chains according to an embodiment of the present disclosure.

FIG. 3 is a flowchart of a text chain generation method according to another embodiment of the present disclosure.

FIG. 4 is a flowchart of a text chain generation method according to another embodiment of the present disclosure.

FIG. 5 is a diagram illustrating the structure of a text chain generation apparatus according to an embodiment of the present disclosure.

FIG. 6 is a diagram illustrating the structure of an electronic device according to an embodiment of the present disclosure.

### DETAILED DESCRIPTION

Embodiments of the present disclosure are described in more detail hereinafter with reference to the drawings. Although some embodiments of the present disclosure are shown in the drawings, it is to be understood that the present disclosure may be implemented in various forms and should not be construed as limited to the embodiments set forth herein; conversely, these embodiments are provided so that the present disclosure will be thoroughly and completely understood. It should be understood that drawings and embodiments of the present disclosure are merely illustrative and are not intended to limit the scope of the present disclosure.

It is to be understood that various steps recited in the method embodiments of the present disclosure may be performed in a different order, and/or in parallel. In addition, the method embodiments may include additional steps and/or omit execution of illustrated steps. The scope of the present disclosure is not limited in this respect.

As used herein, the term “comprise”/“include” and variations thereof are intended to be inclusive, that is, “including, but not limited to”. The term “based on” is “at least partially based on”. The term “an embodiment” refers to “at least one embodiment”; the term “another embodiment” refers to “at least one another embodiment”; the term “some embodiments” refers to “at least some embodiments”. Related definitions of other terms are given in the description hereinafter.

It is to be noted that references to “first”, “second” and the like in the present disclosure are merely intended to distinguish one from another apparatus, module, or unit and are not intended to limit the order or interrelationship of the functions performed by the apparatus, module, or unit.

It is to be noted that references to modifications of “one” or “a plurality” in the present disclosure are intended to be illustrative and not limiting and that those skilled in the art should understand that “one” or “a plurality” should be understood as “one or more” unless clearly expressed in the context.

Names of messages or information exchanged between apparatuses in embodiments of the present disclosure are illustrative and not to limit the scope of the messages or information.

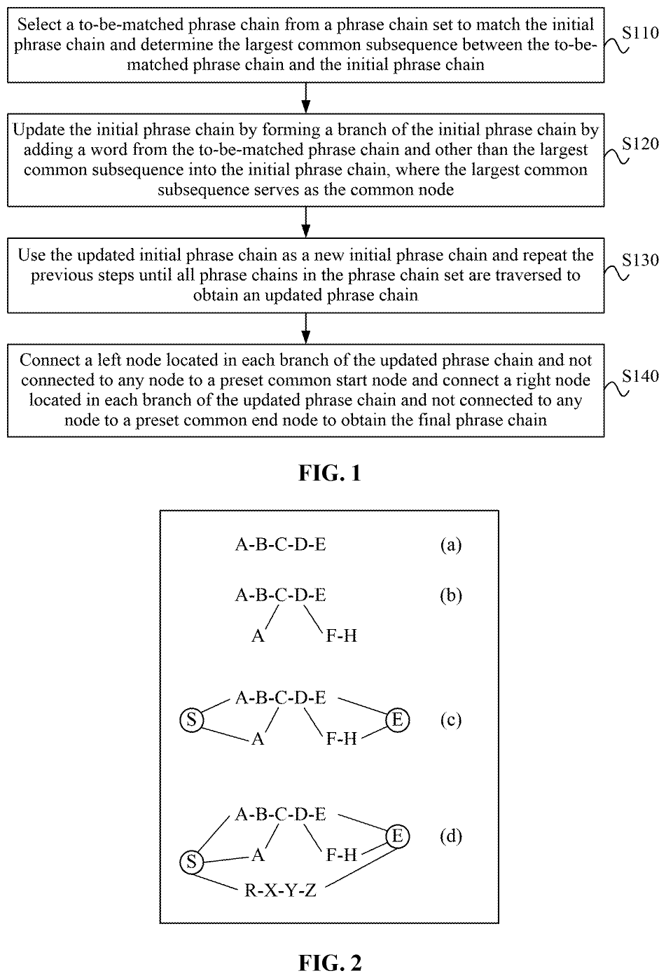

FIG. 1 is a flowchart of a text chain generation method according to an embodiment of the present disclosure. This embodiment of the present disclosure is applicable to the case where more phrase corpuses are constructed and generated based on existing phrase corpuses. The method can be implemented by a text chain generation apparatus, for example, by software and/or hardware in an electronic device.

As shown in FIG. 1, the text chain generation method of this embodiment of the present disclosure includes S110, S120, S130, and S140.

In S110, a to-be-matched phrase chain is selected from a phrase chain set to match the initial phrase chain, and the largest common subsequence between the to-be-matched phrase chain and the initial phrase chain is determined.

The phrase chain refers to a text chain formed by nodes connected in a phrase order, where all words in at least one phrase constitute the nodes. That is, one phrase is one phrase chain. One phrase chain may contain one or more phrases. The phrase chain set is a phrase text data set composed of existing text data. Generally, the length of one phrase is 4 bytes to 10 bytes. For example, referring to the structure of phrase chain (a) of FIG. 2, the phrase (phrase chain) ABCDE contains five characters: A, B, C, D, and E. Each character is one node of the phrase chain. It is feasible to connect the characters in character order to form one phrase chain, for example, a phrase chain composed of Chinese characters “ [symbol] ”. It is also feasible to regard one word as a node and connect the words to form one phrase chain, for example, a phrase chain composed of Chinese words “ [symbol] ”. In this embodiment, characters or words in an existing phrase chain are combined according to a rule so that more phrases can be constructed.

The initial phrase chain is a phrase chain randomly selected from the phrase chain set. Then a phrase chain is randomly selected from phrase chains other than the initial phrase chain to serve as the to-be-matched phrase chain. It is feasible to determine the largest common subsequence between the to-be-matched phrase chain and the initial phrase chain by using, for example, a dynamic programming algorithm: longest common subsequence (LCS). There are three cases in the process of determining the common subsequence. In the first case, there is no common subsequence between the to-be-matched phrase chain and the initial phrase chain, that is, there is no longest common subsequence. In the second case, only one common subsequence is found between the to-be-matched phrase chain and the initial phrase chain, and this only one common subsequence is the longest common subsequence. In the third case, two or more common subsequences are found between the to-be-matched phrase chain and the initial phrase chain, and then the longest common subsequence is required to be selected from these common subsequences. For example, between another phrase chain “A-C-D-F-H” and phrase chain (a) of FIG. 2, the longest common subsequence is “CD”.

In S120, the initial phrase chain is updated by forming a branch of the initial phrase chain by adding a word from the to-be-matched phrase chain and other than the largest common subsequence into the initial phrase chain, where the largest common subsequence serves as the common node.

When the largest common subsequence is found, the largest common subsequence is used as the common node. This can be understood as that the largest common subsequence is regarded as an entirety, and each sequence in the to-be-matched phrase chain and other than the entirety of the largest common subsequence is connected to the initial phrase chain in a word order so that a new phrase chain is formed. See phrase chain (b) of FIG. 2. In phrase chain (b), two branches A and F-H are added. Illustratively, if phrases are obtained based on phrase chain construction, after the updated phrase chain is traversed, new phrases such as “BCDF” and “ABCDFH” can be obtained.

In S130, the updated initial phrase chain is used as a new initial phrase chain, and the previous steps are repeated until all phrase chains in the phrase chain set are traversed to obtain an updated phrase chain.

For example, the updated initial phrase chain is used as a new initial phrase chain, a new phrase chain is selected from the phrase chain set to serve as a to-be-matched phrase chain to match the new initial phrase chain, and then the largest common subsequence between the two is determined. That is, each matching object is updated, and S110 and S120 are repeated until each phrase chain in the phrase chain set is matched to obtain a richer phrase chain.

In S140, a left node located in each branch of the updated phrase chain and not connected to any node is connected to a preset common start node, and a right node located in each branch of the updated phrase chain and not connected to any node is connected to a preset common end node to obtain the final phrase chain.

To ensure a more integral updated phrase chain, all branches of the phrase chain are connected to the same start node and the same end node so that a text chain having a start and an end is obtained. In this manner, during subsequent phrase construction by a phrase chain traversal, there are a definite start and a definite end when a computer program is executed. For example, in the phrase chain (c) of FIG. 2, the first node of each of the two branches before node C of phrase chain (c) is connected to node S, and the last node of each of the two branches after node D of phrase chain (c) is connected to node E.

In response to determining that the to-be-matched phrase chain and the initial phrase chain have no common subsequence, the first node of the to-be-matched phrase chain having no common subsequence with the initial phrase chain is connected to the preset common start node; and the last node of the to-be-matched phrase chain having no common subsequence with the initial phrase chain is connected to the preset common end node. For example, in phrase chain (d) of FIG. 2, the to-be-matched phrase chain “RXYZ” and the updated initial phrase chain (c) have no common subsequence, so node R is connected to the start node S, and node Z is connected to the end node E to obtain the updated phrase chain (d).

When all phrase chains in the phrase chain set are integrated into the final phrase chain, preparation for constructing new phrases is completed, and a preliminary text processing result is obtained.

The solution of this embodiment of the present disclosure includes selecting a to-be-matched phrase chain from a phrase chain set to match the initial phrase chain and determining the largest common subsequence between the to-be-matched phrase chain and the initial phrase chain; updating the initial phrase chain by forming a branch of the initial phrase chain by adding a word from the to-be-matched phrase chain and other than the largest common subsequence into the initial phrase chain, where the largest common subsequence serves as the common node; repeating the previous steps until traversing all phrase chains in the phrase chain set to obtain an updated phrase chain; and connecting a left node located in each branch of the updated phrase chain and not connected to any node to a preset common start node and connecting a right node located in each branch of the updated phrase chain and not connected to any node to a preset common end node to obtain the final complete phrase chain to complete text processing. This solution avoids the case where only a limited number of words can be extracted from the existing text in the related art and makes it possible to form a phrase set based on connection structure reconstruction of words in a phrase, thereby quickly and efficiently generating more phrases and enriching phrase corpus resources.

The process of obtaining the final phrase chain in this embodiment is refined based on the previous embodiment. This embodiment of the present disclosure belongs to the same concept as the text chain generation method of the previous embodiment. For details not described in detail in this embodiment of the present disclosure, see the previous embodiment.

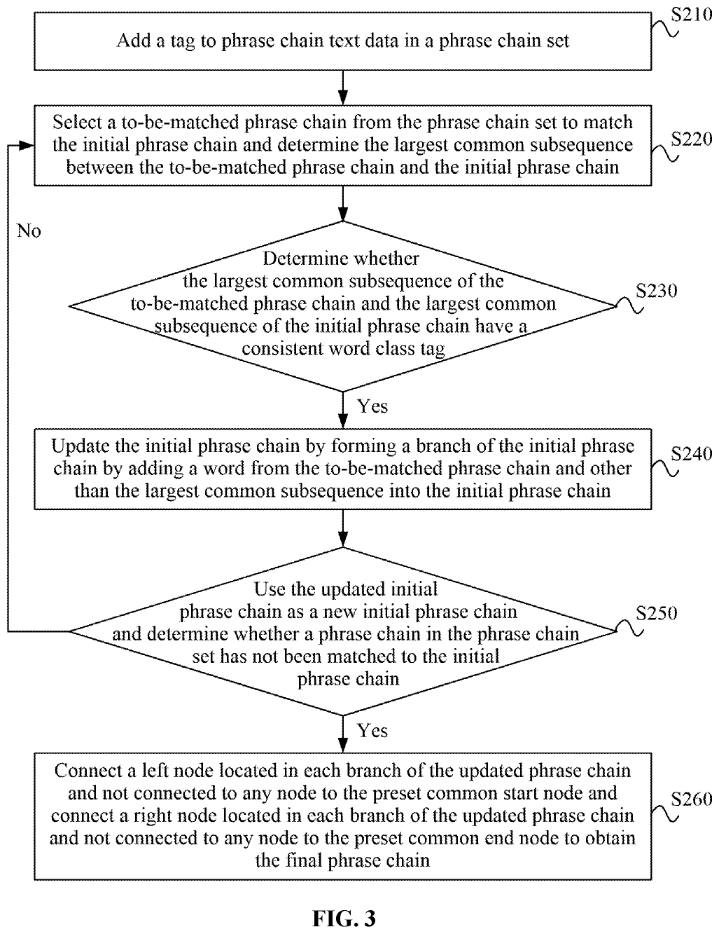

FIG. 3 is a flowchart of a text chain generation method according to another embodiment of the present disclosure. The text chain generation method of this embodiment of the present disclosure includes S210, S220, S230, S240, S250, and S260.

In S210, a tag is added to phrase chain text data in a phrase chain set.

In the phrase chain set, each phrase chain is a selected chain that has a preset length. A character or word in a phrase chain has a word class, for example, noun, verb, or adjective. It is feasible to tag the word class of each node of a phrase chain, that is, add a word class tag to each node of the phrase chain, before matching of a character string, so that it is possible to process text with reference to the word class of each character or word in a subsequent text processing process.

In S220, a to-be-matched phrase chain is selected from the phrase chain set to match the initial phrase chain, and the largest common subsequence between the to-be-matched phrase chain and the initial phrase chain is determined.

The phrase chain refers to a text chain formed by nodes connected in a phrase order, where all words in at least one phrase constitute the nodes. That is, one phrase is one phrase chain. One phrase chain may contain one or more phrases. For details about how to determine the common subsequence between two phrase chains, see S110 in the previous embodiment.

In S230, it is determined whether the largest common subsequence of the to-be-matched phrase chain and the largest common subsequence of the initial phrase chain have a consistent word class tag.

One word may have different word classes. Different word classes in one and the same phrase have different functions. In view of this, a phrase composed of words whose word classes do not conform to a syntactic structure tends to be illogical. Therefore, if the largest common subsequence of two phrase chains has different word class tags, the two phrase chains cannot be integrated using the largest common subsequence as the common node. When the determination result is yes, S240 is performed.

For example, phrase one is “ [symbol] ”, and phrase two is “ [symbol] ”. The word class of “ [symbol] ” is a noun in phrase one, but is a verb in phrase two. If the two phrases are integrated using “ [symbol] ” as the common node, a new phrase “ [symbol] [symbol] ” is obtained. Apparently, the new phrase is syntactically illogical.

In S240, the initial phrase chain is updated by forming a branch of the initial phrase chain by adding a word from the to-be-matched phrase chain and other than the largest common subsequence into the initial phrase chain.

When the determination result is yes, the to-be-matched phrase chain is combined with the initial phrase chain so that the initial phrase chain is updated and a new initial phrase chain is obtained. For details about operations, see S120. If the determination result is no, it is determined whether the largest common subsequence is a unique common subsequence. If yes, it is regarded that the to-be-matched phrase chain and the initial phrase chain have no common subsequence, that is, the first node of the to-be-matched phrase chain is connected to a preset common start node, and the last node of the to-be-matched phrase chain is connected to a preset common end node. If there are other common subsequences in addition to the largest common subsequence, S230 is repeated until the condition in S230 is satisfied or until a conclusion that there is no common subsequence between the two phrase chains is obtained.

In S250, the updated initial phrase chain is used as a new initial phrase chain, and it is determined whether a phrase chain in the phrase chain set has not been matched to the initial phrase chain.

This step is to determine whether a to-be-matched phrase chain in the phrase chain set has not been matched to the initial phrase chain or the updated initial phrase chain. If yes, S220 to S240 are performed to integrate all phrase chains in the phrase chain set into an integral phrase chain. If no, all phrase chains in the phrase chain set have been processed, and S260 is performed.

In S260, a left node located in each branch of the updated phrase chain and not connected to any node is connected to the preset common start node, and a right node located in each branch of the updated phrase chain and not connected to any node is connected to the preset common end node to obtain the final phrase chain.

In the solution of this embodiment of the present disclosure, a phrase chain in a phrase chain set is preprocessed, and a tag is added to phrase chain text data in the phrase chain set; a to-be-matched phrase chain is selected from the phrase chain set to match the initial phrase chain, and the largest common subsequence between the to-be-matched phrase chain and the initial phrase chain is determined; it is determined whether the largest common subsequence of the to-be-matched phrase chain and the largest common subsequence of the initial phrase chain have a consistent word class tag; only when the largest common subsequence satisfies the word class condition, can the to-be-matched phrase chain be combined into the initial phrase chain by using the largest common subsequence as the common node so that a branch of the initial phrase chain is formed and so that the initial phrase chain is updated; the previous steps are repeated until all phrase chains in the phrase chain set are traversed to obtain an updated phrase chain; and a left node located in each branch of the updated phrase chain and not connected to any node is connected to the preset common start node, and a right node located in each branch of the updated phrase chain and not connected to any node is connected to the preset common end node to obtain the final complete phrase chain to complete text processing. This solution avoids the case where only a limited number of words can be extracted from the existing text in the related art, avoids the case where a phrase generated by a neural network model may be illogical, and makes it possible to form a phrase set based on connection structure reconstruction of words in a phrase, thereby quickly and efficiently generating more phrases, ensuring the syntactic logic of a constructed phrase, and enriching phrase corpus resources.

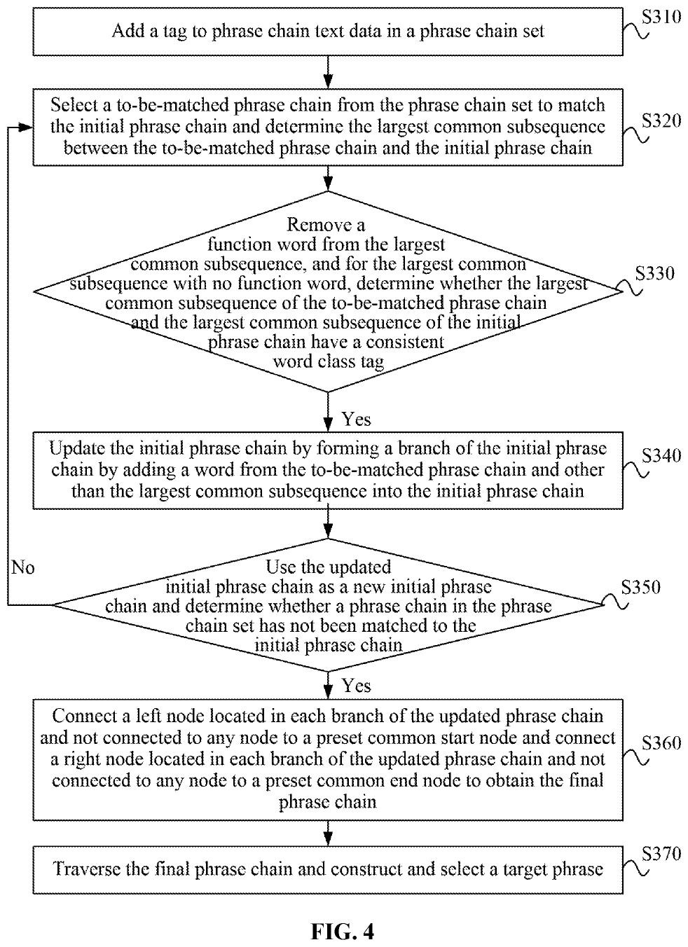

FIG. 4 is a flowchart of a text chain generation method according to another embodiment of the present disclosure. The process of constructing a phrase is described in this embodiment based on the previous embodiment. This embodiment of the present disclosure belongs to the same concept as the text chain generation method of the previous embodiment. For details not described in detail in this embodiment, see the previous embodiment.

As shown in FIG. 4, the text chain generation method includes S310, S320, S330, S340, S350, S360, and S370.

In S310, a tag is added to phrase chain text data in a phrase chain set.

When a phrase chain in the phrase chain set is preprocessed, a word tag in addition to a word class tag may be added to the character or word of each node of the phrase chain to indicate the position of the each node in the phrase chain. For example, the first node of the phrase chain is tagged as the start node, the last node in the phrase chain is tagged as the last node, and a node other than the first node and the last node is tagged as an intermediate node. This may be used as a reference for a word order during text processing.

In different application fields, a phrase chain set may contain different text contents. In an example, phrases in a phrase chain set may be used for describing bidding words of a product, and this phrase chain set may be composed of phrases extracted from product details or titles. After multiple phrase chains are integrated, more phrases can be constructed to serve as bidding words of a product.

In S320, a to-be-matched phrase chain is selected from the phrase chain set to match the initial phrase chain, and the largest common subsequence between the to-be-matched phrase chain and the initial phrase chain is determined.

In S330, a function word is removed from the largest common subsequence, and for the largest common subsequence with no function word, it is determined whether the largest common subsequence of the to-be-matched phrase chain and the largest common subsequence of the initial phrase chain have a consistent word class tag.

A function word generally refers to a word that has no complete meaning but has a syntactic meaning or function, such as “ [symbol] ”, “ [symbol] ”, “ [symbol] ”, “ [symbol] ”, “ [symbol] ”, “ [symbol] ”, or “ [symbol] ”. This is to prevent a linguistically illogical phrase from arising from an improper function word during subsequent phrase construction.

After removing a function word from the largest common subsequence, text processing can be performed according to the matching process described in the preceding embodiment. It is determined whether the largest common subsequences of different phrase chains have the same word class tag. If yes, S340 is performed.

In S340, the initial phrase chain is updated by forming a branch of the initial phrase chain by adding a word from the to-be-matched phrase chain and other than the largest common subsequence into the initial phrase chain.

In S350, the updated initial phrase chain is used as a new initial phrase chain, and it is determined whether a phrase chain in the phrase chain set has not been matched to the initial phrase chain.

This step is to determine whether a to-be-matched phrase chain in the phrase chain set has not been matched to the initial phrase chain or the updated initial phrase chain. If yes, S320 to S340 are performed to integrate all phrase chains in the phrase chain set into an integral phrase chain. If no, all phrase chains in the phrase chain set have been processed, and S360 is performed.

In S360, a left node located in each branch of the updated phrase chain and not connected to any node is connected to a preset common start node, and a right node located in each branch of the updated phrase chain and not connected to any node is connected to a preset common end node to obtain the final phrase chain.

In S370, the final phrase chain is traversed, and a target phrase is constructed and selected.

For example, phrases are constructed as follows: selecting nodes whose quantity is equal to the length of a window by moving the window along nodes of each branch of the final phrase chain from the common start node. Each time the length of the window is set to a different value, the final phrase chain is traversed once again.

Phrase construction is performed by using phrase chain (d) of FIG. 2 as an example. The set length of the window is the selected length of a phrase. For example, the window has a length of four characters, the following phrases can be obtained after traversal: “ABCD,” “BCDE”, “BCDF”, “CDFH”, “ACDF”, and “RXYZ”.

For example, it is also feasible to select a phrase from phrases of a preset length to serve as the target phrase, where each word of the selected phrase has a word order and a word order tag that are consistent with each other. This step is to filter out a phrase that has a character order or a word order is at a syntactically illogical position. If a word suitable at the start is placed at the end after a phrase is constructed, then this phrase is linguistically illogical and thus is filtered out. For example, the word “because” is usually connected to a reason located after the word “because”, for example, “because of a low price” or “because of love”. If “because” is placed at the last node of a phrase, for example, “XXXXX because”, then people feel that the sentence is not complete and that the meaning is not completely expressed. Such a phrase is expressively illogical and thus is not applicable to a certain scenario.

In the solution of this embodiment of the present disclosure, a phrase chain in a phrase chain set is preprocessed, and a tag is added to phrase chain text data in the phrase chain set so that a phrase can be selected during phrase construction and so that after the largest common subsequence is found between the to-be-matched phrase chain and the initial phrase chain, a function word can be removed from the largest common subsequence; it is determined whether the largest common subsequence of the to-be-matched phrase chain and the largest common subsequence of the initial phrase chain have a consistent word class tag; only when the largest common subsequence satisfies the word class condition, can the to-be-matched phrase chain be combined into the initial phrase chain by using the largest common subsequence as the common node so that a branch of the initial phrase chain is formed and so that the initial phrase chain is updated; the previous steps are repeated until all phrase chains in the phrase chain set are traversed to obtain an updated phrase chain; and a left node located in each branch of the updated phrase chain and not connected to any node is connected to the preset common start node, and a right node located in each branch of the updated phrase chain and not connected to any node is connected to the preset common end node to obtain the final complete phrase chain so that a new phrase can be constructed and generated based on the complete phrase chain to complete text processing. This solution avoids the case where only a limited number of words can be extracted from the existing text in the related art, avoids the case where a phrase generated by a neural network model may be illogical, and makes it possible to form a phrase set based on connection structure reconstruction of words in a phrase, thereby quickly and efficiently generating more phrases, ensuring the syntactic logic of a constructed phrase, and enriching phrase corpus resources.

FIG. 5 is a diagram illustrating the structure of a text chain generation apparatus according to an embodiment of the present disclosure. This embodiment of the present disclosure is applicable to the case where more phrase corpuses are constructed and generated based on existing phrase corpuses. The text chain generation apparatus of the present disclosure can perform the text chain generation method of any previous embodiment.

As shown in FIG. 5, the text chain generation apparatus of this embodiment of the present disclosure includes a common sequence matching module 410, a phrase chain update module 420, a matching chain update module 430, and a text processing module 440.

The common sequence matching module 410 is configured to select a to-be-matched phrase chain from a phrase chain set to match the initial phrase chain and determine the largest common subsequence between the to-be-matched phrase chain and the initial phrase chain, where the phrase chain set includes multiple phrase chains, where each of the multiple phrase chains refers to a text chain formed by nodes connected in a phrase order, where all words in at least one phrase constitute the nodes. The phrase chain update module 420 is configured to update the initial phrase chain by forming a branch of the initial phrase chain by adding a word from the to-be-matched phrase chain and other than the largest common subsequence into the initial phrase chain, where the largest common subsequence serves as the common node. The matching chain update module 430 is configured to use the updated initial phrase chain as a new initial phrase chain and call the common sequence matching module and the phrase chain update module to repeat the previous steps until traversing all phrase chains in the phrase chain set to obtain an updated phrase chain. The text processing module 440 is configured to connect a left node located in each branch of the updated phrase chain and not connected to any node to a preset common start node and connect a right node located in each branch of the updated phrase chain and not connected to any node to a preset common end node to obtain the final phrase chain.

The solution of this embodiment includes selecting a to-be-matched phrase chain from a phrase chain set to match the initial phrase chain and determining the largest common subsequence between the to-be-matched phrase chain and the initial phrase chain; updating the initial phrase chain by forming a branch of the initial phrase chain by adding a word from the to-be-matched phrase chain and other than the largest common subsequence into the initial phrase chain, where the largest common subsequence serves as the common node; repeating the previous steps until traversing all phrase chains in the phrase chain set to obtain an updated phrase chain; and connecting a left node located in each branch of the updated phrase chain and not connected to any node to a preset common start node and connecting a right node located in each branch of the updated phrase chain and not connected to any node to a preset common end node to obtain the final complete phrase chain to complete text processing. This solution avoids the case where only a limited number of words can be extracted from the existing text in the related art and makes it possible to form a phrase set based on connection structure reconstruction of words in a phrase, thereby quickly and efficiently generating more phrases and enriching phrase corpus resources.

The apparatus also includes a text preprocessing module. The text preprocessing module is configured to, before the to-be-matched phrase chain is matched to the initial phrase chain, select phrases of a preset length from a text database to generate the phrase chain set, where the phrase chain set includes the multiple phrase chains; and add at least one of a word class tag or a word order tag to a word in each of the multiple phrase chains in the phrase chain set.

The phrase chain update module 420 is configured to determine whether the largest common subsequence of the to-be-matched phrase chain and the largest common subsequence of the initial phrase chain have a consistent word class tag; and in response to determining that a first word class tag of the largest common subsequence of the to-be-matched phrase chain and a second word class tag of the largest common subsequence of the initial phrase chain are the same, add the word from the to-be-matched phrase chain and other than the largest common subsequence to the initial phrase chain.

The text processing module 440 is also configured to, in response to determining that the to-be-matched phrase chain and the initial phrase chain have no common subsequence, connect the first node of the to-be-matched phrase chain to the preset common start node; and connect the last node of the to-be-matched phrase chain to the preset common end node.

The common sequence matching module 410 is also configured to remove a function word from the largest common subsequence.

The text chain generation apparatus also includes a phrase construction module. The phrase construction module is configured to traverse the final phrase chain and construct and select a target phrase.

For example, the phrase construction module is configured to construct phrases by selecting nodes whose quantity is equal to the length of a window by moving the window along nodes of each branch of the final phrase chain from the common start node, where the length of the window has different values in different traversal processes; and select phrases of the preset length from the constructed phrases; and select a phrase from the phrases of the preset length to serve as the target phrase, where each word of the selected phrase has a word order and a word order tag that are consistent with each other.

The text chain generation apparatus of this embodiment of the present disclosure belongs to the same concept as the text chain generation method of any previous embodiment. For details not described in detail in this embodiment of the present disclosure, see the previous embodiments. This embodiment of the present disclosure has the same beneficial effects as the previous embodiments.

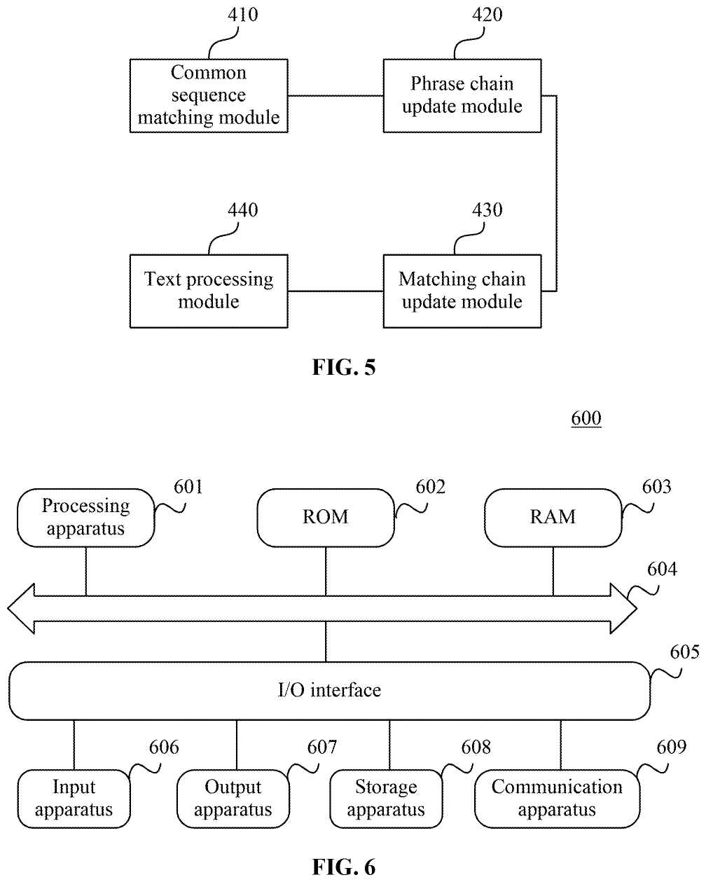

FIG. 6 is a diagram illustrating the structure of an electronic device 600 according to an embodiment of the present disclosure. The electronic device of this embodiment of the present disclosure may include, but is not limited to, a mobile terminal or a fixed terminal. The mobile terminal may be, for example, a mobile phone, a laptop, a digital radio receiver, a personal digital assistant (PDA), a tablet computer, a portable media player (PMP), or a vehicle-mounted terminal (such as a vehicle-mounted navigation terminal). The fixed terminal may be, for example, a digital television (DTV) or a desktop computer. The electronic device shown in FIG. 6 is an example and is not intended to limit the function and use range of this embodiment of the present disclosure.

As shown in FIG. 6, the electronic device 600 may include a processing apparatus 601 (such as a central processing unit or a graphics processing unit). The processing apparatus 601 may perform various types of appropriate operations and processing according to a program stored in a read-only memory (ROM) 602 or a program loaded from a storage apparatus 606 to a random-access memory (RAM) 603. The RAM 603 also stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 604 such as a touch screen, a touch pad, a keyboard, a mouse, a camera, a microphone, an accelerometer and a gyroscope; an output apparatus 607 such as a liquid crystal display (LCD), a speaker and a vibrator; the storage apparatus 606 such as a magnetic tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it is to be understood that not all the apparatuses shown herein need to be implemented or present. Alternatively, more or fewer apparatuses may be implemented or included.

Particularly, according to the embodiments of the present disclosure, the processes described above with reference to the flowcharts may be implemented as computer software programs. For example, a computer program product is included in the embodiment of the present disclosure. The computer program product includes a computer program carried on a non-transitory computer-readable medium. The computer program includes program codes for performing the methods shown in the flowcharts. In such an embodiment, the computer program may be downloaded from a network and installed through the communication apparatus 609 or may be installed from the storage apparatus 606, or may be installed from the ROM 602. When the computer program is executed by the processing apparatus 601, the preceding functions defined in the method of the embodiments of the present disclosure are performed.

It is to be noted that the preceding computer-readable medium in the present disclosure may be a computer-readable signal medium or a computer-readable storage medium or any combination thereof. The computer-readable storage medium may be, but is not limited to, an electrical, magnetic, optical, electromagnetic, infrared or semiconductor system, apparatus or device, or any combination thereof. More specific examples of the computer-readable storage medium may include, but are not limited to, an electrical connection with one or more wires, a portable computer magnetic disk, a hard disk, a random-access memory (RAM), a read-only memory (ROM), an erasable programmable read-only memory (EPROM), a flash memory, an optical fiber, a portable compact disc read-only memory (CD-ROM), an optical storage device, a magnetic storage device, or any appropriate combination thereof. In the present disclosure, the computer-readable storage medium may be any tangible medium including or storing a program that can be used by or in connection with an instruction execution system, apparatus or device. In the present disclosure, the computer-readable signal medium may include a data signal propagated on a baseband or as part of a carrier, where computer-readable program codes are carried in the data signal. The data signal propagated in this manner may be in multiple forms and includes, but is not limited to, an electromagnetic signal, an optical signal, or any suitable combination thereof. The computer-readable signal medium may also be any computer-readable medium except the computer-readable storage medium. The computer-readable signal medium may send, propagate or transmit a program used by or in connection with an instruction execution system, apparatus or device. The program codes included on the computer-readable medium may be transmitted via any appropriate medium which includes, but is not limited to, a wire, an optical cable, a radio frequency (RF) or any appropriate combination thereof.

In some embodiments, clients and servers may communicate using any network protocol currently known or to be developed in the future, such as HyperText Transfer Protocol (HTTP), and may be interconnected with any form or medium of digital data communication (such as a communication network). Examples of the communication network include a local area network (LAN), a wide area network (WAN), an internet (such as the Internet) and a peer-to-peer network (such as an Ad-Hoc network), as well as any network currently known or to be developed in the future.

The preceding computer-readable medium may be included in the preceding electronic device or may exist alone without being assembled into the electronic device.

The computer-readable medium carries one or more programs. When the one or more programs are executed by the electronic device, the electronic device performs the following: selecting a to-be-matched phrase chain from a phrase chain set to match the initial phrase chain and determining the largest common subsequence between the to-be-matched phrase chain and the initial phrase chain, where the phrase chain set includes multiple phrase chains, where each of the multiple phrase chains refers to a text chain formed by nodes connected in a phrase order, where all words in at least one phrase constitute the nodes; updating the initial phrase chain by forming a branch of the initial phrase chain by adding a word from the to-be-matched phrase chain and other than the largest common subsequence into the initial phrase chain, where the largest common subsequence serves as the common node; using the updated initial phrase chain as a new initial phrase chain and repeating the previous steps until traversing all phrase chains in the phrase chain set to obtain an updated phrase chain; and connecting a left node located in each branch of the updated phrase chain and not connected to any node to a preset common start node and connecting a right node located in each branch of the updated phrase chain and not connected to any node to a preset common end node to obtain the final phrase chain.

Computer program codes for performing the operations in the present disclosure may be written in one or more programming languages or a combination thereof. The preceding one or more programming languages include, but are not limited to, object-oriented programming languages such as Java, Smalltalk and C++, as well as conventional procedural programming languages such as C or similar programming languages. The program codes may be executed entirely on a user computer, executed partly on a user computer, executed as a stand-alone software package, executed partly on a user computer and partly on a remote computer, or executed entirely on a remote computer or a server. In the case where a remote computer is involved, the remote computer may be connected to a user computer via any type of network including a local area network (LAN) or a wide area network (WAN) or may be connected to an external computer (for example, via the Internet provided by an Internet service provider).

Flowcharts and block diagrams among the drawings illustrate the architecture, functionality and operation of possible implementations of systems, methods and computer program products according to various embodiments of the present disclosure. In this regard, each block in the flowcharts or block diagrams may represent a module, program segment or part of codes, where the module, program segment or part of codes includes one or more executable instructions for implementing specified logical functions. It is to be noted that in some alternative implementations, the functions marked in the blocks may occur in an order different from that marked in the drawings. For example, two successive blocks may, in practice, be executed substantially in parallel or executed in a reverse order, which depends on the functions involved. It is also to be noted that each block in the block diagrams and/or flowcharts and a combination of blocks in the block diagrams and/or flowcharts may be implemented by a special-purpose hardware-based system which performs specified functions or operations or a combination of special-purpose hardware and computer instructions.

The units involved in the embodiments of the present disclosure may be implemented by software or hardware. The names of the units do not constitute a limitation on the units themselves. For example, a first acquisition unit may also be described as “a unit for acquiring at least two Internet protocol addresses”.

The functions described above herein may be executed at least in part by one or more hardware logic components. For example, without limitations, example types of hardware logic components that may be used include: a field-programmable gate array (FPGA), an application-specific integrated circuit (ASIC), an application-specific standard product (ASSP), a system on a chip (SOC), a complex programmable logic device (CPLD) and the like.

In the context of the present disclosure, a machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device or any appropriate combination thereof. Concrete examples of the machine-readable storage medium include an electrical connection based on one or more wires, a portable computer disk, a hard disk, a RAM, a ROM, an erasable programmable read-only memory (EPROM), a flash memory, an optical fiber, a portable compact disc read-only memory (CD-ROM), an optical storage device, a magnetic storage device, or any appropriate combination thereof.

According to one or more embodiments of the present disclosure, [example one] provides a text chain generation method. The method includes selecting a to-be-matched phrase chain from a phrase chain set to match the initial phrase chain and determining the largest common subsequence between the to-be-matched phrase chain and the initial phrase chain, where the phrase chain refers to a text chain formed by nodes connected in a phrase order, where all words in at least one phrase constitute the nodes; updating the initial phrase chain by forming a branch of the initial phrase chain by adding a word from the to-be-matched phrase chain and other than the largest common subsequence into the initial phrase chain, where the largest common subsequence serves as the common node; using the updated initial phrase chain as a new initial phrase chain and repeating the previous steps until traversing all phrase chains in the phrase chain set to obtain an updated phrase chain; and connecting a left node located in each branch of the updated phrase chain and not connected to any node to a preset common start node and connecting a right node located in each branch of the updated phrase chain and not connected to any node to a preset common end node to obtain the final phrase chain.

According to one or more embodiments of the present disclosure, [example two] illustrates that the method of example one also includes, before matching the to-be-matched phrase chain to the initial phrase chain, selecting phrases of a preset length from a text database to generate the phrase chain set, where the phrase chain set includes the multiple phrase chains; and adding at least one of a word class tag or a word order tag to a word in each of the multiple phrase chains in the phrase chain set.

According to one or more embodiments of the present disclosure, [example three] illustrates that in the method of example two, adding the word from the to-be-matched phrase chain and other than the largest common subsequence into the initial phrase chain, where the largest common subsequence serves as the common node includes determining whether the largest common subsequence of the to-be-matched phrase chain and the largest common subsequence of the initial phrase chain have a consistent word class tag; and in response to determining that a first word class tag of the largest common subsequence of the to-be-matched phrase chain and a second word class tag of the largest common subsequence of the initial phrase chain are the same, adding the word from the to-be-matched phrase chain and other than the largest common subsequence into the initial phrase chain.

According to one or more embodiments of the present disclosure, [example four] illustrates that the method of example one also includes, in response to determining that the to-be-matched phrase chain and the initial phrase chain have no common subsequence, connecting the first node of the to-be-matched phrase chain to the preset common start node; and connecting the last node of the to-be-matched phrase chain to the preset common end node.

According to one or more embodiments of the present disclosure, [example five] illustrates that the method of example four also includes removing a function word from the largest common subsequence.

According to one or more embodiments of the present disclosure, [example six] illustrates that the method of example two also includes traversing the final phrase chain and constructing and selecting a target phrase.

According to one or more embodiments of the present disclosure, [example seven] illustrates that in the method of example six, traversing the final phrase chain and constructing and selecting the target phrase includes constructing phrases by selecting nodes whose quantity is equal to the length of a window by moving the window along nodes of each branch of the final phrase chain from the common start node, where the length of the window has different values in different traversal processes; and selecting phrases of the preset length from the constructed phrases; and selecting a phrase from the phrases of the preset length to serve as the target phrase, where each word of the selected phrase has a word order and a word order tag that are consistent with each other.

According to one or more embodiments of the present disclosure, [example eight] provides a text chain generation apparatus. The apparatus includes a common sequence matching module configured to select a to-be-matched phrase chain from a phrase chain set to match the initial phrase chain and determine the largest common subsequence between the to-be-matched phrase chain and the initial phrase chain, where the phrase chain refers to a text chain formed by nodes connected in a phrase order, where all words in at least one phrase constitute the nodes; a phrase chain update module configured to update the initial phrase chain by forming a branch of the initial phrase chain by adding a word from the to-be-matched phrase chain and other than the largest common subsequence into the initial phrase chain, where the largest common subsequence serves as the common node; a matching chain update module configured to use the updated initial phrase chain as a new initial phrase chain and call the common sequence matching module and the phrase chain update module to repeat the previous steps until traversing all phrase chains in the phrase chain set to obtain an updated phrase chain; and a text processing module configured to connect a left node located in each branch of the updated phrase chain and not connected to any node to a preset common start node and connect a right node located in each branch of the updated phrase chain and not connected to any node to a preset common end node to obtain the final phrase chain.

According to one or more embodiments of the present disclosure, [example nine] illustrates that the apparatus of example eight also includes a text preprocessing module configured to, before the to-be-matched phrase chain is matched to the initial phrase chain, select phrases of a preset length from a text database to generate the phrase chain set, where the phrase chain set includes the multiple phrase chains; and add at least one of a word class tag or a word order tag to a word in each of the multiple phrase chains in the phrase chain set.

According to one or more embodiments of the present disclosure, [example ten] illustrates that in the apparatus of example nine, the phrase chain update module is configured to determine whether the largest common subsequence of the to-be-matched phrase chain and the largest common subsequence of the initial phrase chain have a consistent word class tag; and in response to determining that a first word class tag of the largest common subsequence of the to-be-matched phrase chain and a second word class tag of the largest common subsequence of the initial phrase chain are the same, add the word from the to-be-matched phrase chain and other than the largest common subsequence into the initial phrase chain.

According to one or more embodiments of the present disclosure, [example eleven] illustrates that in the apparatus of example eight, the text processing module is also configured to, in response to determining that the to-be-matched phrase chain and the initial phrase chain have no common subsequence, connect the first node of the to-be-matched phrase chain to the preset common start node; and connect the last node of the to-be-matched phrase chain to the preset common end node.

According to one or more embodiments of the present disclosure, [example twelve] illustrates that in the apparatus of example eleven, the common sequence matching module is also configured to remove a function word from the largest common subsequence.

According to one or more embodiments of the present disclosure, [example thirteen] illustrates that the apparatus of example eight also includes a phrase construction module configured to traverse the final phrase chain and construct and select a target phrase.

According to one or more embodiments of the present disclosure, [example fourteen] illustrates that in the apparatus of example thirteen, the phrase construction module is configured to construct phrases by selecting nodes whose quantity is equal to the length of a window by moving the window along nodes of each branch of the final phrase chain from the common start node, where the length of the window has different values in different traversal processes; and select phrases of the preset length from the constructed phrases; and select a phrase from the phrases of the preset length to serve as the target phrase, where each word of the selected phrase has a word order and a word order tag that are consistent with each other.

The preceding description is merely illustrative of example embodiments of the present disclosure and the technical principles used therein. Those of ordinary skill in the art should understand that the scope referred to in the present disclosure is not limited to the technical solutions formed by the particular combination of the preceding technical features, but intended to cover other technical solutions which may be formed by any combination of the preceding technical features or their equivalents without departing from the concept of the present disclosure. For example, technical solutions formed by mutual substitutions of the preceding feature and the technical features disclosed in the present disclosure (but not limited to) that have similar functions.

In addition, although the operations are depicted in a particular order, this should not be construed as requiring that such operations should be performed in the particular order shown or in a sequential order. In certain circumstances, multitasking and parallel processing may be advantageous. Similarly, although specific implementation details are included in the above discussion, these should not be construed as limiting the scope of the present disclosure. Some features described in the context of separate embodiments may also be implemented in combination in a single embodiment. Conversely, various features described in the context of a single embodiment may also be implemented in multiple embodiments, individually or in any suitable sub-combination.

1. A text chain generation method, comprising:
selecting a to-be-matched phrase chain from a phrase chain set to match an initial phrase chain and determining a largest common subsequence between the to-be-matched phrase chain and the initial phrase chain, wherein the phrase chain set comprises a plurality of phrase chains, wherein each of the plurality of phrase chains refers to a text chain formed by nodes connected in a phrase order, wherein all words in at least one phrase constitute the nodes;
updating the initial phrase chain by forming a branch of the initial phrase chain by adding a word from the to-be-matched phrase chain and other than the largest common subsequence into the initial phrase chain, wherein the largest common subsequence serves as a common node;
using an updated initial phrase chain as a new initial phrase chain and repeating previous steps until traversing all phrase chains in the phrase chain set to obtain an updated phrase chain; and
connecting a left node located in each branch of the updated phrase chain and not connected to any node to a preset common start node and connecting a right node located in each branch of the updated phrase chain and not connected to any node to a preset common end node to obtain a final phrase chain.

2. The method of claim 1, before matching the to-be-matched phrase chain to the initial phrase chain, the method further comprising:
selecting phrases of a preset length from a text database to generate the phrase chain set, wherein the phrase chain set comprises the plurality of phrase chains; and
adding at least one of a word class tag or a word order tag to a word in each of the plurality of phrase chains in the phrase chain set.

3. The method of claim 2, wherein adding the word from the to-be-matched phrase chain and other than the largest common subsequence into the initial phrase chain, wherein the largest common subsequence serves as the common node comprises:
determining whether the largest common subsequence of the to-be-matched phrase chain and the largest common subsequence of the initial phrase chain have a consistent word class tag; and
in response to determining that a first word class tag of the largest common subsequence of the to-be-matched phrase chain and a second word class tag of the largest common subsequence of the initial phrase chain are identical, adding the word from the to-be-matched phrase chain and other than the largest common subsequence into the initial phrase chain.

4. The method of claim 1, in response to determining that the to-be-matched phrase chain and the initial phrase chain have no common subsequence, the method further comprising:
connecting a first node of the to-be-matched phrase chain to the preset common start node; and
connecting a last node of the to-be-matched phrase chain to the preset common end node.

5. The method of claim 4, further comprising:
removing a function word from the largest common subsequence.

6. The method of claim 2, further comprising:
traversing the final phrase chain and constructing and selecting a target phrase.

7. The method of claim 6, wherein traversing the final phrase chain and constructing and selecting the target phrase comprises:
constructing phrases by selecting nodes whose quantity is equal to a length of a window by moving the window along nodes of each branch of the final phrase chain from the common start node, wherein the length of the window has different values in different traversal processes; and selecting phrases of the preset length from constructed phrases; and
selecting a phrase from the phrases of the preset length to serve as the target phrase, wherein each word of a selected phrase has a word order and a word order tag that are consistent with each other.

8. (canceled)

9. An electronic device, comprising:
one or more processors; and
a memory configured to store one or more programs,
wherein when the one or more programs are executed by the one or more processors, the one or more processors perform a text chain generation method,
wherein the text chain generation method comprises:
selecting a to-be-matched phrase chain from a phrase chain set to match an initial phrase chain and determining a largest common subsequence between the to-be-matched phrase chain and the initial phrase chain, wherein the phrase chain set comprises a plurality of phrase chains, wherein each of the plurality of phrase chains refers to a text chain formed by nodes connected in a phrase order, wherein all words in at least one phrase constitute the nodes;
updating the initial phrase chain by forming a branch of the initial phrase chain by adding a word from the to-be-matched phrase chain and other than the largest common subsequence into the initial phrase chain, wherein the largest common subsequence serves as a common node;
using an updated initial phrase chain as a new initial phrase chain and repeating previous steps until traversing all phrase chains in the phrase chain set to obtain an updated phrase chain; and
connecting a left node located in each branch of the updated phrase chain and not connected to any node to a preset common start node and connecting a right node located in each branch of the updated phrase chain and not connected to any node to a preset common end node to obtain a final phrase chain.

10. A non-transitory computer storage medium, storing a computer program which, when executed by a processor, causes the processor to perform a text chain generation method,
wherein the text chain generation method comprises:
selecting a to-be-matched phrase chain from a phrase chain set to match an initial phrase chain and determining a largest common subsequence between the to-be-matched phrase chain and the initial phrase chain, wherein the phrase chain set comprises a plurality of phrase chains, wherein each of the plurality of phrase chains refers to a text chain formed by nodes connected in a phrase order, wherein all words in at least one phrase constitute the nodes;
updating the initial phrase chain by forming a branch of the initial phrase chain by adding a word from the to-be-matched phrase chain and other than the largest common subsequence into the initial phrase chain, wherein the largest common subsequence serves as a common node;
using an updated initial phrase chain as a new initial phrase chain and repeating previous steps until traversing all phrase chains in the phrase chain set to obtain an updated phrase chain; and
connecting a left node located in each branch of the updated phrase chain and not connected to any node to a preset common start node and connecting a right node located in each branch of the updated phrase chain and not connected to any node to a preset common end node to obtain a final phrase chain.

11. The electronic device of claim 9, before matching the to-be-matched phrase chain to the initial phrase chain, the method further comprising:
selecting phrases of a preset length from a text database to generate the phrase chain set, wherein the phrase chain set comprises the plurality of phrase chains; and
adding at least one of a word class tag or a word order tag to a word in each of the plurality of phrase chains in the phrase chain set.

12. The electronic device of claim 11, wherein adding the word from the to-be-matched phrase chain and other than the largest common subsequence into the initial phrase chain, wherein the largest common subsequence serves as the common node comprises:
determining whether the largest common subsequence of the to-be-matched phrase chain and the largest common subsequence of the initial phrase chain have a consistent word class tag; and
in response to determining that a first word class tag of the largest common subsequence of the to-be-matched phrase chain and a second word class tag of the largest common subsequence of the initial phrase chain are identical, adding the word from the to-be-matched phrase chain and other than the largest common subsequence into the initial phrase chain.

13. The electronic device of claim 9, in response to determining that the to-be-matched phrase chain and the initial phrase chain have no common subsequence, the method further comprising:
connecting a first node of the to-be-matched phrase chain to the preset common start node; and
connecting a last node of the to-be-matched phrase chain to the preset common end node.

14. The electronic device of claim 11, further comprising:
traversing the final phrase chain and constructing and selecting a target phrase.

15. The electronic device of claim 14, wherein traversing the final phrase chain and constructing and selecting the target phrase comprises:
constructing phrases by selecting nodes whose quantity is equal to a length of a window by moving the window along nodes of each branch of the final phrase chain from the common start node, wherein the length of the window has different values in different traversal processes; and selecting phrases of the preset length from constructed phrases; and
selecting a phrase from the phrases of the preset length to serve as the target phrase, wherein each word of a selected phrase has a word order and a word order tag that are consistent with each other.

16. The method of claim 9, before matching the to-be-matched phrase chain to the initial phrase chain, the method further comprising:
selecting phrases of a preset length from a text database to generate the phrase chain set, wherein the phrase chain set comprises the plurality of phrase chains; and
adding at least one of a word class tag or a word order tag to a word in each of the plurality of phrase chains in the phrase chain set.

17. The non-transitory computer storage medium of claim 16, wherein adding the word from the to-be-matched phrase chain and other than the largest common subsequence into the initial phrase chain, wherein the largest common subsequence serves as the common node comprises:
determining whether the largest common subsequence of the to-be-matched phrase chain and the largest common subsequence of the initial phrase chain have a consistent word class tag; and
in response to determining that a first word class tag of the largest common subsequence of the to-be-matched phrase chain and a second word class tag of the largest common subsequence of the initial phrase chain are identical, adding the word from the to-be-matched phrase chain and other than the largest common subsequence into the initial phrase chain.

18. The non-transitory computer storage medium of claim 10, in response to determining that the to-be-matched phrase chain and the initial phrase chain have no common subsequence, the method further comprising:
connecting a first node of the to-be-matched phrase chain to the preset common start node; and
connecting a last node of the to-be-matched phrase chain to the preset common end node.

19. The non-transitory computer storage medium of claim 16, further comprising:
traversing the final phrase chain and constructing and selecting a target phrase.

20. The non-transitory computer storage medium of claim 19, wherein traversing the final phrase chain and constructing and selecting the target phrase comprises:
constructing phrases by selecting nodes whose quantity is equal to a length of a window by moving the window along nodes of each branch of the final phrase chain from the common start node, wherein the length of the window has different values in different traversal processes; and selecting phrases of the preset length from constructed phrases; and
selecting a phrase from the phrases of the preset length to serve as the target phrase, wherein each word of a selected phrase has a word order and a word order tag that are consistent with each other.

21. The method of claim 2, in response to determining that the to-be-matched phrase chain and the initial phrase chain have no common subsequence, the method further comprising:
connecting a first node of the to-be-matched phrase chain to the preset common start node; and
connecting a last node of the to-be-matched phrase chain to the preset common end node.
